(19) United States
(12) Patent Application Publication
(10) Pub. No.: US 2009/0138326 A1
(43) Pub. Date: May 28, 2009

(54) APPARATUS AND METHOD FOR UPDATING USER PROFILE

(75) Inventor: Xiaowei Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,312

(22) PCT Filed: Nov. 14, 2005
(86) PCT No.: PCT/IB05/53732

§ 371 Date: May 15, 2007

(30) Foreign Application Priority Data
Nov. 18, 2004 (CN) 200410095756.5

(51) Int. Cl. G06Q 10/00; G06Q 99/00; G06N 5/02

(52) U.S. Cl. 705/10; 705/1; 706/52

(57) ABSTRACT

The present invention provided a method for updating user profile, and the user profile includes like-degree of the user for at least one content feature. The method includes the following steps of: (a).monitoring the user's behavior to a playing program; (b).acquiring a interest degree of the user for the program according to the behavior to the predetermined content features of the program; (c).adjusting contains like degree and weight of a the interest degree correspondingly according to the like degree for the corresponding content feature in the user profile; (d).modifying the like degree in the user profile for the corresponding content feature according to the adjusted interest degree to the predetermined content features of the program.

### FIELD OF THE INVENTION

This invention relates to an information recommending system, in particular to a method and apparatus for updating user profile in the information recommending system.

### BACKGROUND OF THE INVENTION

With the development of today's telecommunication technology, people could obtain abundant information at any time. However, the rapid increasing of information makes people feel at lost from time to time. People are in the desperate need for finding a tool which may help them find the information they really care, namely a personalized information recommending system.

In order to catch up with the ever-changing interest of the user's, the User Profile in the information recommending system is subject to be constantly updating as well. Therefore, the current issue to be addressed is, how to modify the user profiles in the recommending system dynamically in accordance with the user's interest (preference), so as to recommend the information which the user is really interested in to the user.

At present, the user's like degree and weight for the various content features of a certain program in the user profile are usually modified according to the behavior from the user's watching of a certain program. The user's behavior refers to how long the user has been watching the program, how many times the user has watched and deleted the programs including content features.

The content feature may refer to the respective actors' names (e.g. Fan Bingbing, Ge You etc.), genre (story, romance, thriller etc.), director (Zhang Yimou, Feng Xiaogang etc.) in certain program. The content features may come from broadcast, TV, Internet or other information source. The most typical case is that the content features are sent together with the program to users through Electronic Program Guide (EPG).

However, how many times the user has watched and deleted programs including certain content features can only indicate whether or not the user has watched them, but cannot reflect whether the user is actually interested in them or not. For example, the user skips to a program with certain content features when he is changing channels. It doesn't mean the user is interested in the content feature, and accordingly should be viewed as the user has watched the program once, which then consequently becomes the evidence to modify the user profile. Obviously such practice cannot reflect the actually interest of the user.

Besides, it usually takes some time for the user to watch some part of the program before deciding if he is really interested in it or not. If after watching for a while, however, the user feels that he is not interested in the program, the system still believes that the user has watched it, and then modifies the user's like degree and weight for the certain content features in the user profile. Such practice cannot reflect the interest change of the user correctly too.

Similarly, it is not very accurate either to modify the user's like degree and weight for respective content feature in the user profile based only on the ratio between the watched times and deleted times, and the watched length of the program. For example, here is a program with rather short predetermined total playing time, and the time the user has watched occupies most or even all the total playing time, then the user find out that he is not interested in it at all. It cannot reflect the interest change of the user for the content feature correctly, if the user's like degree and weight for the various content feature in the program are modified by using the ratio between the said total time watched and the total length of the program.

Further, the user watches a certain program only because he has nothing else to do (e.g. watches it with friends, or someone else). If the user's like degree and weight for the various content feature in the program are accordingly modified as the normal situation; it cannot reflect the real interest change of the user comprehensively and accurately too.

In general, it cannot reflect the actual interest change of the user comprehensively and accurately, if the like degree and weight for various content features in the certain program are modified based only on the behaviors that the user has watched a certain program, how long he has watched it, or he has not watched the certain program.

Therefore, it needs to provide a new method and apparatus for updating use profile as well as an information recommending system thereof to modify the user profile more comprehensively and accurately.

### OBJECT AND SUMMARY OF THE INVENTION

One purpose of the present invention is to provide a method and device for updating user profile in order to modify the user profile more comprehensively and accurately, as well as an information recommending system.

The invention disclosed a method for updating user profile that includes the like degree of the user for at least one content feature. The method includes the following steps: (a).monitoring the user's behavior to a playing program; (b).according to the user's behavior, acquiring a interest degree of the user for the program including the predetermined content features; (c).adjusting the interest degree correspondingly according to the like degree for the corresponding content feature in the user profile; (d).modifying the like degree for the corresponding content feature in the user profile according to the adjusted interest degree to the predetermined content features of the program.

The user profile includes the weight of the user for at least one content feature. The method further comprises the steps of: modifying the user's weight for the corresponding content feature in the user profile according to the adjusted interest degree to the predetermined content feature of the program.

In an embodiment of this invention, if the corresponding like degree indicates that the user is not interested in the corresponding content feature in the user profile, the interest degree is adjusted to reduce the effect of the interest degree on the user profile

In another embodiment, if the like degree indicates that the user is interested in the corresponding content feature, the interest degree is adjusted to increase the effect of the interest degree on the user profile.

One of the methods for updating user profile disclosed in this invention is to acquire the interest degree for the program according the ratio of how long the user has watched a particular program and the total predetermined playing time of the program. The interest degree then is compared with the like degree for various content features for the user in the user profile or other history records (e.g. how many times the user has watched or deleted certain program with one or more content features). The interest degree then is adjusted according to the result of the comparison, so as to acquire the interest degree of the user more precisely.

For example, if the original like degree for certain content feature in the user profile was very small or the user rarely watched it, the effect of the interest degree on the like degree is reduced; If the original like degree for certain content feature in the user profile was quite large or the watching time is large, it may not reduce (or reduce it slightly as in the afore-mentioned example where the like degree is very small,), or even increase the effect of the interest degree on the like degree.

Therefore, modifying the user profile through the method disclosed in this invention can reduce the possibility of modifying the user profile in normal situation in some specific conditions, such as when the user is actually watching the program carelessly or at the time of changing channels, or when he is watching it with a friend, so as to update the user profile according to the interest change of the user more accurately.

This invention introduces an apparatus for updating a user profile which includes the like degree of the user for at least one content feature. The apparatus comprises a user interacting means, an interest change analyzing means, an interest change adjusting means and a user profile modifying means. The user interacting means is used to monitor the user's behavior, which relates to a playing program. The interest change analyzing means is for acquiring the interest degree of the user for the program, according to the user's behavior, which interest degree is to the predetermined content features of the program. The interest change adjusting means is for adjusting the interest degree correspondingly according to the like degree for the corresponding content feature in the user profile. The user profile-modifying means is for modifying the like degree for the corresponding content feature in the user profile, according to the adjusted interest degree to the predetermined content features of the program.

The user profile includes the weight of the user for at least one content feature, wherein the user profile modifying device is also used to modify the weight of the corresponding content feature in the user profile, according to the adjusted interest degree for the predetermined content features of the program.

One embodiment of this invention is that the interest change adjusting device is also used to acquire the like degree for the corresponding content feature in the user profile. If the like degree indicates that the user is not interested in the content feature, the interest degree is adjusted to reduce the effect of the interest degree on the user profile.

Another embodiment of this invention is that the interest change adjusting device is also used to acquire the like degree for the corresponding content feature in the user profile. If the like degree indicates that the user is interested in the content feature, said interest degree is adjusted to increase the effect of the interest degree on the user profile.

Therefore, modifying the user profile through the device disclosed in this invention reduce the possibility of modifying the user profile as in normal situation in some specific conditions, such as when the user is actually watching the program carelessly or at the time of changing channels, or when he is watching it with a friend, so as to update the user profile according to the interest change of the user more accurately.

The information recommending system disclosed in this invention comprises a program receiving means, a user profile management means, a selecting means, a user interacting means, an interest change analyzing means, an interest change adjusting means and a user profile-modifying means. Wherein the program receiving means is for receiving program information. The user profile management means is for storing user profile, which includes the like degree of the user for at least one content feature. The selecting means is for selecting the program information, which might be preferred to the user, from the program information, according to the user profile, so as to recommend those selected information to the user. The user interacting means is for monitoring the user's behavior to the recommended program information. The interest change analyzing means is for acquiring the interest degree of the user for the program according to the user's behavior, which interest degree relates to the predetermined content feature of the program. The interest change adjusting means is for adjusting the interest degree according to the like degree for the corresponding content feature in the user profile. The user profile modifying means for modifying the like degree for the corresponding content feature in, the user profile, according to the adjusted interest degree for the predetermined content feature of the program.

The method, apparatus and the information recommending system thereof for updating user profile disclosed in this invention, combine the user's behavior of watching a particular program with his or her like degree and weight in the original user profile for various content features of the program, to modify the user's like degree and weight for the said various content features, so as to follow up the interest change of the user more comprehensively and accurately and therefore modify the user's like degree and weight for the content features accordingly.

In some specific conditions, such as when the user is actually watching the program carelessly or at the time of changing channels, or when he is watching it with a friend, the invention can reduce the possibility of modifying the user profile as in normal situation, so as to update the user profile according to the interest change of the user more accurately.

Other objects and achievement of the present invention will become apparent from the following description and claims in conjunction with the accompanying drawings, as well as a comprehensive understanding of this invention.

### BRIEF DESCRIPTION OF DRAWINGS

According to the embodiments of the invention, the invention is explained in detail with respect to the figures attached, among which:

FIG. 1 is a structure schematic diagram of an information recommending system according to an embodiment of this invention.

FIG. 2 is a flow chart of a method for updating user profile according to an embodiment of this invention.

FIG. 3 is another flow chart of updating user profile according to an embodiment of this invention.

FIG. 4 is the graph of the fuzzy input variable e1 of FIG. 3

FIG. 5 the graph of the fuzzy input variable e2 of FIG. 3

FIG. 6 is the graph of the fuzzy output variable αᵢⱼ of FIG. 3

Among all the figures, same reference number refers to identical or similar features and functions.

### DETAILED DESCRIPTION OF THE INVENTION

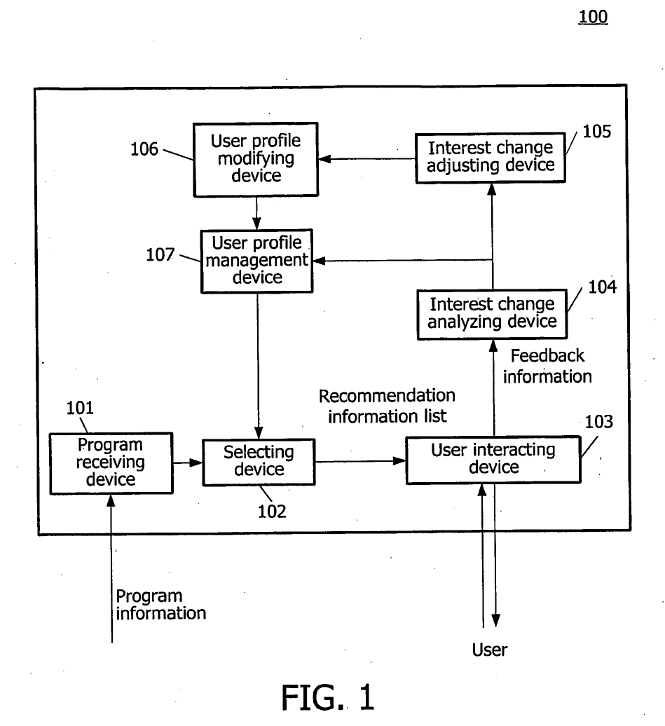

FIG. 1 is a structure schematic diagram of an information recommending system according to an embodiment of this invention.

The system 100 comprises a user interacting device 103, an interest change analyzing device 104, an interest change adjusting device 105 and a user profile-modifying device 106. The user profile includes like degree and weight of the user for at least one content feature.

The content feature refers to actors' names (e.g. Fan Bingbing, Ge You etc.), genre (story, romance, thriller etc.), director (Zhang Yimou, Feng Xiaogang etc.) in certain program. The content features may come from broadcast, TV, Internet or other information source. The most typical practice is that the content features are sent together with the program to the users through Electronic Program Guide (EPG).

The content feature in the user profile can be a single one, for instance, just a particular actor. Of course, the user profile can also'include a plurality of content features, which make the corresponding recommendation result more accurate.

The like degree is the user's reaction to various content features, which can be reflected by a scale, for example, [−50, +50] predetermined by the supplier.

The weight refers to, when the user is selecting programs, the effect of the various types of content features, such as actors, directors and genres, on the choice. In other word, what are the criteria when the user choose his favorite program, i.e. choosing his favorite program based on the actors, genres or directors. Among all the criteria, the weights for all the actors may be the same, or are the weights for all the sorts, or otherwise are the weights for all the directors. The weights can also be a scale, for example [0, 100], which is predetermined by the supplier.

The weight and like degree in the user profile can be the history records of the user's watched programs. When the user is watching programs, there may be some other history information; for example how many times the user has watched and deleted a program with certain content features.

The user interacting device 103 is used to monitor the user's behavior to a playing program. The user interacting device 103, as a interactive bridge between the user and the information recommending system, can collect the feedback information of the programs being watched by the user, and can also present a recommendation information list for the user to choose the programs to watch. The feedback information includes the user's behavior.

The recommendation information list can be represented in table 1:

TABLE 1

| | | | Possible Interest |
|---|---|---|---|
| Channel | Broadcast Time | Name | degree |
| Hunan Satellite | 15:30/September 18 | Empty Mirror | 60 (very |
| TV | | | interested) |
| CCTV-1 | 19:30/September 18 | Tell It as It Is | 45 (interested) |
| CCTV-6 | 21:30/September 18 | Cala, My Dog | 20 (so so) |

The interest change analyzing device 104 is used to acquire the interest degree of the user for the program, which interest degree is to the predetermined content features of the programs, according to the afore-mentioned user's behavior.

The said interest degree can be expressed as

$$\frac{( {WD}_{i} - θ )}{{RD}_{i}} * 10$$

where WDᵢ indicates how long the user has been watching a particular program; θ is a pre-set threshold value, which may be provided by the supplier, and which usually is 0.5RDᵢ. RDᵢ refers to the total predetermined playing time of the program.

The interest change adjusting device 105 is used to adjust the interest degree according to the like degree for the corresponding content feature in the user profile. The interest degree can be adjusted by a different coefficient, the range of which can be set by the supplier, for instance [0.1, 1].

For example, for a content the user likes from the beginning (the like degree is high), the interest degree can be multiplied with a coefficient 0.9 or 1. For a content feature the user dislikes from the beginning (the like degree is low), the interest degree can be multiplied with a coefficient 0.1 or even smaller, so as to reduce the effect of the interest degree on the like degree, as the user might have to watch said content features with a friend or for other reasons.

Of course, if the like degree of the user for certain content feature is quite high in the user profile, the effect of the interest degree on the user profile can also be increased, namely the range of the adjusting coefficient is not restricted to said [0.1, 1], and may also exceed 1.

The user profile modifying device 106 is used to modify the like degree and weight for the corresponding content features in the user profile according to the adjusted interest degree for the predetermined content features of the program, so as to update the user profile dynamically and more accurately.

The system also includes a program receiving device 101, a selecting device 102 and a user profile management device 107.

The program receiving device 101 is used to receive program information and the Electronic Program Guide (EPG) corresponding to the program, and etc.

The selecting device 102 is used to select those program information preferred by users, according to the program information received and the user profile, to list the user preferred program information in the recommendation list.

The user profile management device 107 is used to manage the user profile. The user profile typically includes the like degree and weight of the user for multiple of content features.

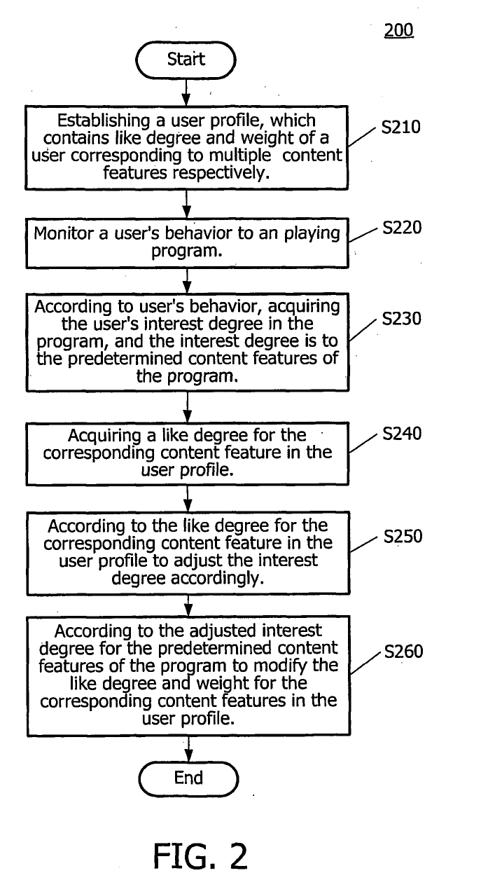

FIG. 2 is a flow chart schematic diagram of a method for updating the user profile according to an embodiment of this invention.

Firstly, a user profile is established, which includes like degree and weight of a user for multiple content features. (Step S210)

The content feature may refer to the actors' names (e.g. Fan Bingbing, Ge You etc;), genre (story, romance, thriller etc.), director (Zhang Yimou, Feng Xiaogang etc.) in certain program. The content features may come from broadcast, TV, Internet or other information source. The most typical practice is that the content features are sent together with the program to users through Electronic Program Guide (EPG).

The content feature in the user profile can be a single one, for instance, just a particular actor. Of course, the user profile can also include a plurality of content features, which make the corresponding recommendation result more accurate.

The like degree is the user's reaction to various content features, which can be a scale predetermined by the supplier, for example, [−50, +50].

The weight refers to, when the user is selecting programs, the effect of the various types of content features, like actors, directors and genres on the choice. In other word, what are the criteria when the user is choosing his favorite program, i.e. choosing his favorite program based on the actors, genres or directors. Among all the criteria, the weights for all the actors might be the same, or are the weights for all the sorts, or otherwise are the weights for all the directors. The weight can also be reflected by a scale predetermined by the supplier, such as [0, 100].

The weight and like degree in the user profile can be the history records of the user's watching programs. When the user is watching program, there may be some other history information, for example how many times the user has watched and deleted a specific program with certain content features.

The user profile can be filled and initialized by the user himself. Which of course, is not the only way. There are other ways available to acquire the user profile. For example, the producer can initialize the user profile of the recommending system according to the user's basic information (e.g. gender, age, etc).

The user profile includes a series of content features, each of which further includes a ternary array (Term, Like degree, Weight). Accordingly, the user profile (UP for short) can be represented by a vector of a ternary array (t, ld, w). If there are m different content features in the user profile, it then can be expressed by the vector array below:

UP=((t₁,ld₁,w₁), (t₂,ld₂,w₂), . . . (t₁,ld₁,w₁) . . . , (tₘ,ldₘ,wₘ)) (1)

Here, tᵢ is a content feature; i is the index of the content feature tᵢ; while ldᵢ is the like degree for the content feature tᵢ; and wᵢ is the weight for the content feature tᵢ.

Assuming that a user profile in the current history record is as follows:

| Program genre: | weight = 90 |
|---|---|
| Movie | like degree = 50 |
| Opera | like degree = 30 |
| News | like degree = −20, |
| | (negative value indicates the dislike degree), |

Therefore, the ternary array of the user's interest degree for content features of the above sort is (movie, 50, 90);

| Actor: | weight = 80 |
|---|---|
| A | like degree = 45 |
| B | like degree = 40 |
| C | like degree = −12.5 |

Therefore, the ternary array of the user's interest degree for actor C is (C, −12.5, 80),

The ternary array of the user's interest degree for actor A is (A, 45, 80).

Secondly, monitoring a user's behavior for a playing program (step S220). The user's behavior includes how long the user has been watching the program with one or more predetermined content features, and how many times the user has watched and deleted the programs with the particular content features. The playing program may be the one picked out from the recommendation information list.

For example, the playing program is Movie A, which is a predetermined content feature. The program also includes one or more other content features, for instance, actor A and actor C, etc. All these content features can be set by the supplier of the program or can be sent to the user by the Electronic Program Guide (EPG) together with the program.

Thirdly, according to user's behavior, the user's interest degree for the program can be acquired, and the interest degree is to the predetermined content features of the program (step S230). Generally, it is acquired according to how long the user has watched the program, the total predetermined playing time of the program and a predetermined threshold value.

The interest degree can be expressed as

$$\frac{( {WD}_{i} - θ )}{{RD}_{i}} * 10$$

where WDᵢ indicates how long the user has watched the program, θ is a pre-set threshold value, RDᵢ is the total predetermined playing time of a particular program. The predetermined values can be set by the supplier, for example, if RDᵢ is 2 hours, θ can be set to 0.5 hour. If WDᵢ is less than 0.5 hour, the interest degree shall be 0.

As the aforementioned, there is a movie A, the total predetermined playing time of which is 2 hours, and θ is 0.5 hour, while the user has been watching it for 1.5 hours. According to the formula

$$\frac{( {WD}_{i} - θ )}{{RD}_{i}} * 10$$

the user's interest degree for the program is 5. Or in other word, the user's interest degrees for all the content features in the program are 5, namely the user's interest degrees for movie A, actor A and actor C are 5.

Fourthly, acquiring the like degree for the corresponding content feature in the user profile (step S240). The corresponding content features correspond to those in the program. The like degrees are available for the content features already in the user profile.

Of course, the weight for the corresponding content features in the user profile can also be acquired. There are also weights available for the corresponding content features in the user profile.

It is also possible for certain content features of the program to have no corresponding content feature in the user profile. Therefore, the like degrees for those content features are set to be 0, while weight shall be in accordance to the same sort, i.e. the actor shall be subject to the weight for the actor in the profile, and genre shall be subject to the weight for the genre in the profile.

For example, actor A and actor C in the respective content features of the movie A correspond to content features of actor A and actor C in the profile. The like degree for actor A in the said user profile is 45, and weight is 80; while the like degree for actor C in the said user profile is −12.5 and weight is the same 80.

Fifthly, according to the like degree for the corresponding content feature in the user profile, the interest degree is adjusted accordingly (step S250).

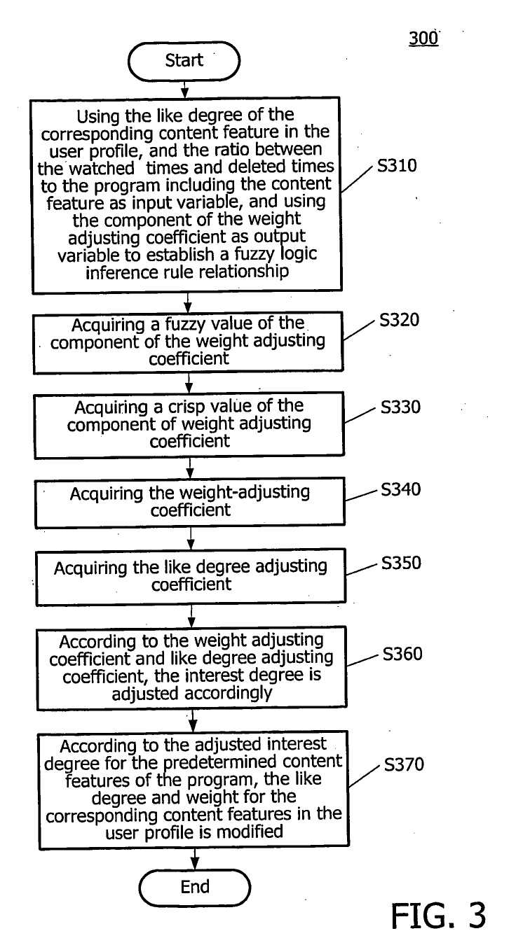

The interest degree can be adjusted by a coefficient, which can be a positive decimal equaling to or less than 1. The scale of the coefficient can be set by the supplier, for instance [0.1, 1]. The coefficient can also be acquired dynamically through the combination of the user's like degree and other history record information. For example, the like degree in the user profile and the ratio of times that a user has watched and deleted the content features can be combined together as the inputs to obtain said coefficient by the way of fuzzy logic inference rule. (For detailed steps, please refer to the FIG. 3 described below).

Movie A still as the example, the like degree in its corresponding user profile for the content feature, actor A, is 45, which indicates that the user likes the content feature originally, actor A, or he is interested in actor A. In this case, a greater coefficient, for instance 0.9, can be adopted to adjust the interest degree 5, and the adjusted interest degree for actor A becomes to 4.5. The adjusting range is rather small, which reduces the effect of the interest degree on the user profile to a small extent.

While for the content feature, actor C, its corresponding like degree in the user profile is −12.5, which indicates the user does not like the content feature; actor C, or he is not interested in content feature Actor C originally. Under such circumstances, a smaller coefficient, for instance 0.3, can be adopted to adjust the interest degree 5, and the adjusted interest degree for actor C becomes to 1.5. The adjusting range is rather large, which reduces the effect of the interest degree on the user profile to a large extent.

Of course, if the user's like degree for certain content feature is very high in the profile, the effect of the interest degree on the user file can also be increased. That is to say, the range of the adjusting coefficient is not restricted to [0.1, 1], which can also be greater than 1.

The adjusted interest degree is used to modify the corresponding like degree and weight. Accordingly, when adjusting the interest degree that is used to modify the like degree, a like degree adjusting coefficient can also be adopted; when adjusting the interest degree that is to modify the weight, a weight adjusting coefficient can also be adopted. The two coefficients are correlative, for example, the weight adjusting coefficient is affected by the like degree-adjusting coefficient, they are in a proportional dependence, and etc. Of course, a same coefficient may also be adopted to adjust the weight and like degree at the same time.

The like degrees for content features in the user profile which correspond to the said content features are different, so that the like degree-adjusting coefficients and weight adjusting coefficients which correspond to respective content feature may also different. As a result, the adjusted interest degrees which correspond to the respective content features in the program may be different too. For example, the adjusted interest degrees for the content features actor A and the adjusted interest degrees for actor C are different.

Sixthly, according to the adjusted interest degree for the predetermined content features of the program, the like degree and weights for the corresponding content features in the user profile is modified (step S260), so as to dynamically modify the user profile more accurately.

Modifying the like degree and weight for the content features in the user profile can be represented by the following formula:

$$\begin{matrix}{Weight}_{ti}^{′} = {Weight}_{ti} + {α}_{t} \cdot \frac{( {WD}_{i} - θ )}{{RD}_{i}} & ( 2 ) \\ {Like\_degree}_{i}^{′} = {Like\_degree}_{i} + {β}_{i} \cdot \frac{( {WD}_{i} - θ )}{{RD}_{i}} & ( 3 )\end{matrix}$$

Here, t(Term) is the content feature; i is the index of the content feature, namely content feature i; and weightₜᵢ is the initial weight for the content feature i; while the like degreeᵢ is the user's initial like degree for the content feature i. Weight′ₜᵢ is the changed weight for the content feature i; and like degree's is the changed like degree of the user. WDᵢ stands for how long the user has actually watched the program with content feature i; RDᵢ is the total predetermined playing time of the program and θ is the predetermined threshold.

αₜ and βᵢ are the weight adjusting coefficient and like degree adjusting coefficient, respectively. βᵢ and αₜ are correlated with each other, for example, in a proportional dependence, and etc. αₜ and βᵢ are used to adjust the interest degree of the weight for the content feature i

$$\frac{( {WD}_{i} - θ )}{{RD}_{i}} * 10$$

and that of the like degree for the content feature i

$$\frac{( {WD}_{i} - θ )}{{RD}_{i}} * 10.$$

αₜ and βᵢ are normally used to postpone the change of the weight and like degree. They are less than or equal to 1 (maybe larger than 1). Since the weight of the user's like is relatively stable, αₜ≦βᵢ.

When calculating,

If Weight′ᵢ is greater than 100, set Weight′ᵢ=100;

If Weight′ᵢ is less than 0, set Weight′ᵢ=0;

If like degree′ᵢ is greater than 50, set like degree′₁=50;

If like degree′ᵢ is less than −50, set like degree′ᵢ=−50;

The following description is based on the movie A as well:

The modification of the user's like degree and weight for actor A can be represented as:

Suppose αₜ=0.1βᵢ; where βᵢ is afore-mentioned 0.9, therefore αₜ is 0.09; here i refers to the content feature actor C;

$$\begin{matrix}\begin{matrix}{Like\_degree}_{i}^{′} = {Like\_degree}_{i} + {β}_{i} \cdot \frac{( {WD}_{i} - θ )}{{RD}_{i}} \\ = 45 + 0.9 * 5 \\ = 49.5 ;\end{matrix} & \\ \begin{matrix}{Weight}_{ti}^{′} = {Weight}_{ti} + {α}_{t} \cdot \frac{( {WD}_{i} - θ )}{{RD}_{i}} \\ = 80 + 0.09 * 5 \\ = 80.45 .\end{matrix} & \end{matrix}$$

The modification of the user's like degree and weight for actor C can be represented as:

Suppose αₜ=0.3βᵢ; βᵢ is 0.3 as aforementioned. Therefore αₜ is 0.09; here i refers to the content feature actor C;

$$\begin{matrix}\begin{matrix}{Like\_degree}_{i}^{′} = {Like\_degree}_{i} + {β}_{i} \cdot \frac{( {WD}_{i} - θ )}{{RD}_{i}} \\ = - 12.5 + 0.3 * 5 \\ = - 11 ;\end{matrix} \\ \begin{matrix}{Weight}_{ti}^{′} = {Weight}_{ti} + {α}_{t} \cdot \frac{( {WD}_{i} - θ )}{{RD}_{i}} \\ = 80 + 0.09 * 5 \\ = 80.45 .\end{matrix}\end{matrix}$$

Both actor A and actor C belong to the type of actor, therefore the modified weights are the same, both for 80.45.

Normally, the same weight is used for the same type (e.g. actor), while weight is subject to αₜ, namely subject to the adjusted interest degree. Therefore, it is enough to calculate the weight for the same type one time.

In the method for updating the user profile introduced in this invention, after the user's interest degree for the content feature is acquired through the ratio of how long the user has been watching the program to how long is the total predetermined playing time of the program. Then, the interest degree is compared with the user's like degree for the various content features of the program or other history records (e.g. how many times the certain program with said one or more content features are watched or deleted). And the interest degree shall be adjusted according to the comparison, so as to acquire the user's interest degree more accurately.

For example, if the like degree for the corresponding content feature in the user profile is not high or the times a user watches the feature is small, the effect of the interest degree on the like degree for the corresponding content feature is reduced; if the initial like degree for the corresponding content feature in the user profile is high, the effect of the interest degree on the like degree for the corresponding content feature will not be reduced.

Therefore, in some particular circumstances, for example, when the user is actually watching the program carelessly, when he is changing channels, or when he is watching it with a friend who is interested in it, the possibility of modifying the user profile as the normal case is reduced by using the method disclosed here, so as to update the user profile according to the interest change of the user more accurately.

FIG. 3 is another flow chart of updating the user profile according to an embodiment of this invention.

Firstly, using the like degree e2 for the corresponding content feature in the user profile, and the ratio e1 between the watched times and deleted times as input variables, and using the component αᵢⱼ of the weight adjusting coefficient αₜ as output variable, to establish a fuzzy logic inference rule converting relationship between multi-inputs and a single output (step S310). That is to say, the like degree for the corresponding content features and other history records in the user profile, which refer to watched times and deleted times for the programs including the content features, are set as the input variables for the fuzzy logic inference rule, so as to acquire the output variable αᵢⱼ, in which

e1=Pfᵢ(+)/Pfᵢ(−), e2=Like degreeᵢ.

Pfᵢ(+)/Pfᵢ(−) comes from the statistics of watched times and deleted times to some programs including certain content features. For detailed information, refer to table 2:

In the table, Nf_{Gi}(+) or Nf_{Aj}(+) stand for watched times to the programs with content features Gᵢ (content feature i on relevant program type) or Aⱼ (content feature j on relevant actor), including the current record. Nf_{Gi}(−) or Nf_{Aj}(−) refer to deleted times to the programs with content features Gᵢ or Aⱼ, including the current record. Every time the user watches programs with content features Gᵢ or Aᵢ, Nf_{Gi}(+) or Nf_{Aj}(+) will be incremented by 1, while every time the user deletes programs with content features Gᵢ or Aᵢ, NfGi(−) or NfAj(−) will be decremented by 1.

TABLE 2

| Classification | | Watch Times | Delete Times |
|---|---|---|---|
| Program genre | Content feature 1 | Nf_{G1}(+) | Nf_{G1}(−) |
| | . . . | . . . | . . . |
| | Content feature i | Nf_{Gi}(+) | Nf_{Gi}(−) |
| | . . . | . . . | . . . |
| | Content feature m | Nf_{Gm}(+) | Nf_{Gm}(−) |
| Actor | Content feature 1 | Nf_{A1}(+) | Nf_{A1}(−) |
| | . . . | . . . | . . . |
| | Content feature j | Nf_{Aj}(+) | Nf_{Aj}(−) |
| | . . . | . . . | . . . |
| | Content feature l | Nf_{Al}(+) | Nf_{Al}(−) |

Through Pfᵢ(+)=Nfᵢ(+)/Nf(+) and Pfᵢ(−)—Nfᵢ(−)/Nf(−) the ratio Pfᵢ(+)/Pfᵢ(−) is acquired.

Nf(+) refers to watched times to the programs with all the content features; while Nf(−) refers to deleted times to the programs with all the content features, namely Nf(+)=ΣNfᵢ(+), Nf(−)=ΣNfᵢ(−).

Secondly, through fuzzy logic inference rule, the fuzzy value of the component of the weight adjusting coefficient is acquired. (S320).

In the process of said fuzzy logic inference rule, assuming that the program is divided into n time sections. αⱼᵢ refers to the component of the corresponding weight adjusting coefficient for the j-th time section of the content feature i.

Through the relationship between multi-inputs and single output variable, the component αⱼᵢ of the weight adjusting coefficient is acquired by using the fuzzy logic inference rule. In this embodiment, the fuzzy value of αⱼᵢ is acquired by fuzzy e1 and e2.

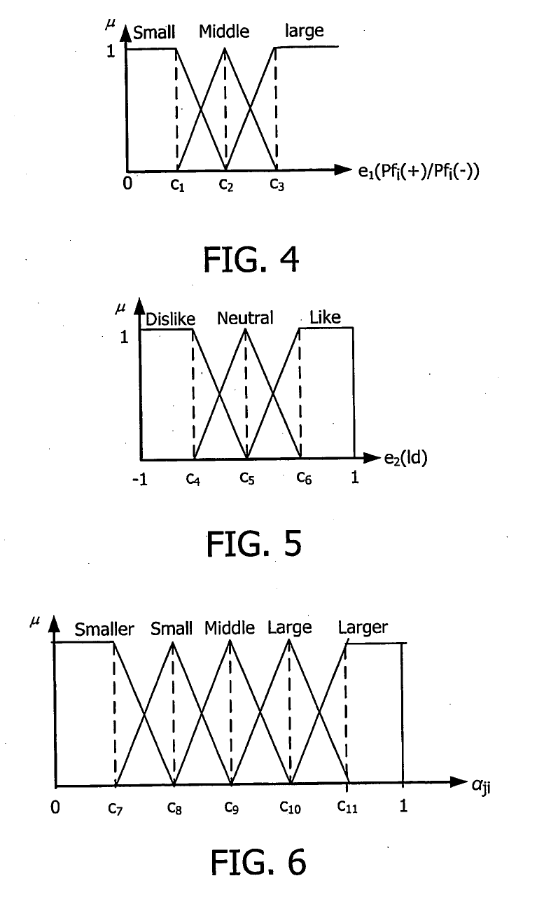

Explanation to the detailed inference procedure shall be made with reference to FIG. 4, FIG. 5 and FIG. 6. FIG. 4 is the fuzzy graph of input variable e1; FIG. 5 is the fuzzy graph of input variable e2; while FIG. 6 is the fuzzy graph of the output variable aᵢⱼ which is deduced from the input variables e1 and e2 by means of fuzzy logic inference rule. The user's consistency of his present and past interest (the change of the interest degree) reflects to what extent his interest degree should be modified. If the consistency of the present and past interest is low, more adjustments are needed, therefore, αⱼᵢ is smaller, otherwise αⱼᵢ is larger. Therefore, the specific fuzzy logic inference rule are as follows:

I. If e1 is “large”, and e2 is “like”, thus αⱼᵢ is “large”;

II. If e1 is “large”, and e2 is “neutral”, thus αⱼᵢ is “larger”;

III. If e1 is “large”, and e2 is “dislike”, thus αⱼᵢ is “middle”;

IV. If e1 is “middle”, and e2 is “like”, thus αⱼᵢ is “larger”;

V. If e1 is “middle”, and e2 is “neutral”, thus αⱼᵢ is “middle”;

VI. If e1 is “middle”, and e2 is “dislike”, thus αⱼᵢ is “smaller”;

VII. If e1 is “small”, and e2 is “like”, thus αⱼᵢ is “middle”;

VIII. If e1 is “small”, and e2 is “neutral”, thus αji is “smaller”;

IX. If e1 is “small”, and e2 is “dislike”, thus αⱼᵢ is “small”.

The value μ in FIG. 4 and FIG. 5 indicates the subjection degrees of e1 and e2. The subjection degrees μ in FIG. 6 is acquired from the subjection degrees of e1 and e2 in FIG. 4 and FIG. 5.

Thirdly, acquire a crisp value of the component of weight adjusting coefficient (step S330). Namely, the fuzzy value of said weight adjusting coefficient αⱼᵢ is clarified, to acquire the crisp value of the weight adjusting coefficient component αⱼᵢ.

In order to make the final result be easily understood, the result of fuzzy logic reference rule must be converted into clarified value. The most common deblurring algorithms are area gravity center method and maximum average value method. The former, which is suitable for smooth control, synthesizes the rules of all the activated outputs as the result, and it is the common method for process control.

This embodiment adopts Center of Area Method Defuzzification Method, which is represented by the formula (4)

$${α}_{ij} = {\sum }_{i = 1}^{p} μ [ l ] {y}_{i} \text{/} {\sum }_{i = 1}^{p} μ [ l ] \qquad ( 4 )$$

wherein,

μ[1] represents deducing the height of the output area from the first rule;

y1 represents deducing the X-axis of the gravity of the output area from the first rule;

p represents the satisfied number of deduced rules.

According to said formula, the crisp value of αⱼᵢ is obtained. For detailed procedure, please refer to Chinese Patent Application No. 200310123354.7.

Fourthly, acquire the weight adjusting coefficient (step S340), which further includes the following two steps:

A, Obtain the average value of the component of the weight adjusting coefficient αⱼᵢ, among which αₜⱼ is the average of αⱼᵢ corresponding all the content features belonging to type t (such as actor, director, program genre, etc),i.e. the weight adjusting coefficient αₜⱼ for type t in each and every time section. The procedure can be realized by the formula below:

$${α}_{ij} = \frac{{α}_{ij 1} + … {α}_{iji} + … + {α}_{ijm}}{m} \qquad ( 5 )$$

Here, m represent that there are m content features in the type t.

B, Based on the average value obtained, the weight adjusting coefficient is obtained. The weight adjusting coefficient αₜ for the H-type information is obtained as follows:

$${α}_{t} = \frac{{α}_{t 1} + … + \frac{1}{j} {α}_{tj} + … + \frac{1}{n} {α}_{tn}}{1 + … + \frac{1}{j} + … + \frac{1}{n}} \qquad ( 6 )$$

where n refers to the number of the time section.

Fifthly, obtain the like degree adjusting coefficient (step S350).

Based on the crisp value of the weight adjusting coefficient component obtained, the like degree adjusting coefficient can be obtained as well. The like degree adjusting coefficient βᵢ can be obtained as follows:

$${β}_{i} = \frac{{α}_{1 i} + … + \frac{1}{j} {α}_{ji} + … + \frac{1}{n} {α}_{ni}}{1 + … + \frac{1}{j} + … + \frac{1}{n}} \qquad ( 7 )$$

where n refers to the number of time section; while i refers to the content feature i.

Sixthly, according to the weight adjusting coefficient αᵢ and like degree adjusting coefficient βᵢ, the interest degree is adjusted accordingly. (step S360).

Seventhly, according to the adjusted interest degree for the predetermined content, features of the program, the like degree and weight for the corresponding content features in the user profile is modified. (step S370).

Although much has been described to explain this invention in reference to the embodiments, for those skilled in the art, it is to make replacements, modifications and variations to the invention. Therefore, such replacements, modifications and variations are included in this invention without departing from the idea and scope of the attached claims.

1. A method for updating a user profile that contains like degree of a user for at least one content feature, the method comprising the following steps of:
(a).monitoring the user's behavior to a playing program;
(b).according to the user's behavior, acquiring a interest degree of the user for the program including predetermined content features;
(c).adjusting the interest degree according to the like degree in the user profile for the corresponding content feature; and
(d).according to the adjusted interest degree to the predetermined content features of the program, modifying the like degree in the user profile for the corresponding content feature.

2. The method of claim 1, wherein the user profile contains the weight of the user for at least one content feature, the method further comprises the step of: modifying the user's weight in the user profile for the corresponding content feature according to the adjusted interest degree to the predetermined content feature of the program.

3. The method of claim 1, wherein step (c) further comprises the following steps of:
(i) acquiring the like degree for the corresponding content feature in the user profile; and
(ii) adjusting the interest degree to reduce the effect of the interest degree on the user profile, if the like degree indicates that the user is not interested in the content feature.

4. The method of claim 3, wherein step (ii) further comprises the step of: adjusting the interest degree by multiplying a coefficient that is less than 1 to reduce the effect of the interest degree on the user profile.

5. The method of claim 1, wherein step (c) further comprises the steps of:
acquiring the like degree for the corresponding content feature in the user profile; and
adjusting the interest degree to increase the effect of the interest degree on the user profile, if the like degree indicates that the user is interested in the content feature.

6. The method of claim 1, wherein step (c) further comprises the steps of:
acquiring the like degree for the corresponding content feature in the user file; and
adjusting the interest degree by the way of fuzzy inference according to the like degree.

7. The method of claim 1, wherein the user's behavior includes the time length the user has watched the program.

8. An apparatus for updating user profile that includes like degree of the user for at least one content feature, the apparatus comprises:
a user interacting means for monitoring the user's behavior to a playing program;
an interest change analyzing means for acquiring the interest degree of the user for the program according to the user's behavior, which interest degree is to the predetermined content features of the program;
an interest change adjusting means for adjusting the interest degree correspondingly according to the like degree for the corresponding content feature in the user profile; and
a user profile modifying means for modifying the like degree for the corresponding content feature in the user profile, according to the adjusted interest degree for the predetermined content features of the program.

9. The apparatus of claim 8, wherein the user profile contains the weights of multiple content features, the user profile modifying means is also used to modify the weight of the corresponding content feature in the user profile, according to the adjusted interest degree for the predetermined content features of the program.

10. The apparatus of claim 8, wherein the interest change adjusting means is also used to acquire the like degree for the corresponding content feature in the user profile, and adjust the interest degree to reduce the effect of the interest degree on the user profile, if the like degree indicates that the user is not interested in the content feature.

11. The apparatus of claim 8, wherein the interest change adjusting means is also used to acquire the like degree for the corresponding content feature in the user profile, and adjust the interest degree to increase the effect of the interest degree on the user profile, if the like degree indicates that the user is interested in the content feature.

12. The apparatus of claim 8, wherein the interest change adjusting means is also used to acquire the like degree for the corresponding content feature in the user profile, according to which the interest degree is adjusted by the way of fuzzy inference.

13. The apparatus of claim 8, wherein the user's behavior includes the time length the user has watched the program.

14. An information recommending system comprising:
a program receiving means for receiving program information;
a user profile management means for storing user profile including like degree of the user-for at least one content feature;
a selecting means for selecting the program information which might be preferred to the user from the program information according to the user profile to recommend those selected information to the user;
a user interacting means for monitoring the user's behavior to the recommended program information;
an interest change analyzing means for acquiring the interest degree of the user for the program, according to the user's behavior, which interest degree is to the predetermined content feature of the program;
an interest change adjusting means for adjusting the interest degree according to the like degree for the corresponding content feature in the user profile; and
a user profile modifying means for modifying the like degree for the corresponding content feature in the user profile, according to the adjusted interest degree for the predetermined content feature of the program.
